(19) United States
(12) Patent Application Publication
(10) Pub. No.: US 2023/0332669 A1
(43) Pub. Date: Oct. 19, 2023

(54) VACUUM SYSTEM FOR MITIGATING DAMAGE DUE TO A VACUUM PUMP MALFUNCTION

(71) Applicant: ASML NETHERLANDS B.V., Veldhoven (NL)

(72) Inventors: Erheng WANG, San Jose, CA (US); Adrianus Marinus VERDONCK, Wouwse Plantage (NL); Adjan Gerrard Pieter Ivo SCHEERHOORN, Nieuwerkerk aan den Ijssel, NL (NL); Xu WANG, San Jose, CA (US); Jianzi SUI, Fremont, CA (US); Chin-Fa TU, San Jose, CA (US); Martijn Petrus Christianus VAN HEUMEN, Santa Clara, CA (US)

(73) Assignee: ASML NETHERLANDS B.V., Veldhoven (NL)

(21) Appl. No.: 18/025,636

(22) PCT Filed: Sep. 28, 2021
(86) PCT No.: PCT/EP2021/076550

§ 371 Date: Mar. 9, 2023

Related U.S. Application Data
(60) Provisional application No. 63/085,500, filed on Sep. 30, 2020.

(51) Int. Cl. F16F 15/04

(52) U.S. Cl. CPC F16F 15/04; F16F 2230/0005; F16F 2230/0023; F16F 2230/007; F16F 2230/22

(57) ABSTRACT

A vacuum system configured to mitigate damage or risk associated with a pump malfunction (e.g., an imbalance, a catastrophic failure, etc.). An exemplary vacuum pump includes a housing; a vibration isolator coupled to the vacuum pump housing and configured to isolate vibrations generated by the vacuum pump during operation; and a stop structure disposed between the vacuum pump housing and an adjacent fixture. The stop structure configured to prevent displacement of the vacuum pump housing relative to the fixture above a threshold amount, wherein the displacement of the vacuum pump housing is configured to be within the threshold amount during normal operation. The vacuum system may further include a collar configured to limit an axial displacement of the pump.

### CROSS-REFERENCE TO RELATED APPLICATIONS

This application claims priority of U.S. application 63/085,500 which was filed on Sep. 30, 2020, and which is incorporated herein in its entirety by reference.

### TECHNICAL FIELD

The description herein relates generally to improving a vacuum system. More particularly, components to be included in the vacuum system for mitigating damage and safety risk in an event of a pump malfunction. The vacuum system can be used in lithography, inspection systems, or other vibration sensitive applications.

### BACKGROUND

A lithographic projection apparatus can be used, for example, in the manufacture of integrated circuits (ICs). In such a case, a patterning device (e.g., a mask) may contain or provide a pattern corresponding to an individual layer of the IC (“design layout”), and this pattern can be transferred onto a target portion (e.g. comprising one or more dies) on a substrate (e.g., silicon wafer) that has been coated with a layer of radiation-sensitive material (“resist”), by methods such as irradiating the target portion through the pattern on the patterning device. In general, a single substrate contains a plurality of adjacent target portions to which the pattern is transferred successively by the lithographic projection apparatus, one target portion at a time. In one type of lithographic projection apparatuses, the pattern on the entire patterning device is transferred onto one target portion in one go; such an apparatus is commonly referred to as a stepper. In an alternative apparatus, commonly referred to as a step-and-scan apparatus, a projection beam scans over the patterning device in a given reference direction (the “scanning” direction) while synchronously moving the substrate parallel or anti-parallel to this reference direction. Different portions of the pattern on the patterning device are transferred to one target portion progressively. Since, in general, the lithographic projection apparatus will have a reduction ratio M (e.g., 4), the speed F at which the substrate is moved will be 1/M times that at which the projection beam scans the patterning device. More information with regard to lithographic devices can be found in, for example, U.S. Pat. No. 6,046,792, incorporated herein by reference.

Prior to transferring the pattern from the patterning device to the substrate, the substrate may undergo various procedures, such as priming, resist coating and a soft bake. After exposure, the substrate may be subjected to other procedures (“post-exposure procedures”), such as a post-exposure bake (PEB), development, a hard bake and measurement/inspection of the transferred pattern. This array of procedures is used as a basis to make an individual layer of a device, e.g., an IC. The substrate may then undergo various processes such as etching, ion-implantation (doping), metallization, oxidation, chemo-mechanical polishing, etc., all intended to finish off the individual layer of the device. If several layers are required in the device, then the whole procedure, or a variant thereof, is repeated for each layer. Eventually, a device will be present in each target portion on the substrate. These devices are then separated from one another by a technique such as dicing or sawing, whence the individual devices can be mounted on a carrier, connected to pins, etc.

Thus, manufacturing devices, such as semiconductor devices, typically involve processing a substrate (e.g., a semiconductor wafer) using a number of fabrication processes to form various features and multiple layers of the devices. Such layers and features are typically manufactured and processed using, e.g., deposition, lithography, etch, chemical-mechanical polishing, and ion implantation. Multiple devices may be fabricated on a plurality of dies on a substrate and then separated into individual devices. This device manufacturing process may be considered a patterning process. A patterning process involves a patterning step, such as optical and/or nanoimprint lithography using a patterning device in a lithographic apparatus, to transfer a pattern on the patterning device to a substrate and typically, but optionally, involves one or more related pattern processing steps, such as resist development by a development apparatus, baking of the substrate using a bake tool, etching using the pattern using an etch apparatus, etc.

A vacuum may be provided in at least part of the radiation source, a beam splitting device, and a lithography device in order to minimize the absorption of EUV radiation, among other applications. Different parts of the lithography system may be different at different pressures (i.e., kept at different pressures below atmospheric pressure) and different gas compositions (where different gas mixtures are supplied to the radiation source and the beam splitting device) parts of vacuum.

The lithography apparatus or an inspection system (e.g., a charged particle inspection device) device may be configured such that, in operation, a vacuum pump is connected to the suction ports and pumped through the suction ports, a pressure at an input is maintained to between 10⁻⁷ to 10⁻⁸ Torr (e.g., for metrology tools). A EUV lithography tools may work at a much higher pressure, in the order of 10⁰ Pa. A pressure at an output is maintained to between 10⁻¹ to 10⁰ Torr, for example.

### SUMMARY

In an embodiment, there is provided a vacuum system configured to mitigate damage and safety risk in an event of a pump failure. The system including a first component coupled to a pump and including protruding structures, the pump having a central axis; and a second component coupled to a rigid structure and isolated from the pump by being separated from the pump, the isolation preventing vibration of the pump from being transmitted to the rigid structure via the second component. The second component includes depressions that correspond to the protruding structures. The corresponding protrusion/depression pairs prevent the pump from rotating around the central axis beyond a threshold amount.

Furthermore, in an embodiment, there is provided, a vacuum system including a vacuum pump including a housing; a vibration isolator coupled to the vacuum pump housing and configured to isolate vibrations generated by the vacuum pump during operation; and a stop structure disposed between the vacuum pump housing and an adjacent fixture. The stop structure configured to prevent displacement of the vacuum pump housing relative to the fixture above a threshold amount, wherein the displacement of the vacuum pump housing is configured to be within the threshold amount during normal operation.

In an embodiment, there is provided a vacuum system including a vacuum pump having a housing; a vibration isolator coupled to the vacuum pump housing and configured to isolate vibrations generated by the vacuum pump during operation; and a collar axially coupled to the vacuum pump and configured to prevent displacement of the vacuum pump housing along the axis of rotation of the vacuum pump above an axial threshold amount. The displacement of the vacuum pump housing is configured to be within the axial threshold amount during normal operation.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed embodiments. In the drawings,

FIG. 1 illustrates a block diagram of various subsystems of a lithographic projection apparatus, according to an embodiment.

FIG. 2 illustrates an exemplary lithographic projection apparatus showing a location of a vacuum system, according to an embodiment.

FIG. 3A is an exploded view of an exemplary vacuum system used in the lithographic apparatus, the vacuum system is configured to mitigate damage or risk that may be caused due to a pump malfunction, according to an embodiment;

FIG. 3B is an assembled view of the vacuum system of FIG. 3A, according to an embodiment;

FIG. 4A is a portion of the vacuum system illustrating a stop structure (a first component) configured to limit the displacement of a pump housing in an event of a malfunction, according to an embodiment;

FIG. 4B is a cross-section view of a portion of the assembled vacuum system, the cross-section view illustrating a spacing between the stop structure and a fixture (a second component), according to an embodiment;

FIG. 4C is a top view and a zoomed in view of a portion of the vacuum system illustrating a spacing between the stop structure and a fixture (a second component);

FIG. 5A illustrates an example stress or plastic deformation induced in a slot of the fixture when a protruding portion of the stop structure contacts the fixture upon the pump malfunction, according to an embodiment;

FIG. 5B illustrates an example stress or plastic deformation induced in the protruding portion of the stop structure when contacted with the fixture upon the pump malfunction, according to an embodiment;

FIG. 6 is an isometric view of a collar (a third component) configured to limit the displacement of the pump housing in an axial direction, according to an embodiment;

FIG. 7A is a top view of the collar assembled in the vacuum system, according to an embodiment;

FIG. 7B is a cross-section view of a portion of the collar to illustrate a spacing between the vacuum pump housing and the collar, according to an embodiment;

FIG. 7C illustrates another example collar configuration, according to an embodiment;

FIG. 8 is a schematic diagram of a lithographic projection apparatus, according to an embodiment.

FIG. 9 is a schematic diagram of another lithographic projection apparatus, according to an embodiment.

FIG. 10 is a detailed view of the lithographic projection apparatus, according to an embodiment.

FIG. 11 is a detailed view of the source collector module of the lithographic projection apparatus, according to an embodiment.

FIG. 12 schematically depicts an embodiment of a scanning electron microscope (SEM), according to an embodiment.

FIG. 13 schematically depicts an embodiment of an electron beam inspection apparatus, according to an embodiment.

### DETAILED DESCRIPTION

Manufacturing of electronic devices is a highly complex process that requires repeated use of lithographic projection apparatus and metrology tool. The electronic devices comprises integrated circuit (IC) chips, where each IC chip includes a number of circuit components (transistors, capacitors, diodes, etc.). For example, an IC chip in a smart phone, can be as small as a person's thumbnail, and may include over 2 billion transistors, the size of each transistor being less than 1/1000th the size of a human hair. Making an IC is a complex and time-consuming process, with circuit components in different layers and including hundreds of individual steps. Errors in even one step have the potential to result in problems with the final IC.

The manufacturing of such IC chips require vacuum environment for creating circuit patterns via a lithographic apparatus. Also, vacuum environment is required when measuring, via a metrology tool, circuit patterns on the IC chip. For example, the vacuum environment is for clamping IC chips or radiation beam transmission. Radiation signals of lithographic or metrology tools will be severely weakened, unless beam paths are contained within vacuum or low pressure environments. Such weakened beam will result in manufacturing errors in circuit patterns to be printed on the IC chip.

The vacuum environment is created via a vacuum system. Such vacuum systems include a vacuum pump that operates at a very high speed to generate a vacuum environment. Additionally, vibration isolators may be employed to prevent transmission of vibrations from the pump to the IC chip or the components that interact with the IC chip. The vacuum pump (e.g., a turbo pump) may malfunction and cause catastrophic failure. For example, the pump may catastrophically fail due to inside rotor crashing. The vibration isolator (attached to the vacuum pump) comprises just a flexible thin-wall bellow with rubber damping material. As such, the vibration isolator can easily get damaged and does not provide sufficient safety mechanism. Hence, people or components around pumps may get injured or damaged during a pump malfunction or catastrophic failure. For example, cables and hoses connected to the turbo pumps may swing out to injure people due to rapid rotation of the vacuum pump housing if rotor inside gets jammed with housing. In another example, the vacuum pump can rip off the isolator bellow and fly out to injure people. In the present disclosure, a safety mechanism is provided that limits the vacuum pump displacement during an event of pump malfunction, so as to prevent damage to people or components surrounding the vacuum pump.

Although specific reference may be made in this text to the manufacture of ICs, it should be explicitly understood that the description herein has many other possible applications. For example, it may be employed in the manufacture of integrated optical systems, guidance and detection patterns for magnetic domain memories, liquid-crystal display panels, thin-film magnetic heads, etc. The skilled artisan will appreciate that, in the context of such alternative applications, any use of the terms “reticle”, “wafer” or “die” in this text should be considered as interchangeable with the more general terms “mask”, “substrate” and “target portion”, respectively.

In the present document, the terms “radiation” and “beam” may be used to encompass all types of electromagnetic radiation, including ultraviolet radiation (e.g. with a wavelength of 365, 248, 193, 157 or 126 nm), EUV (extreme ultra-violet radiation, e.g. having a wavelength in the range of about 5-100 nm), and wavelengths (e.g., vacuum UV (VUV), extreme UV (EUV), soft x-ray (SXR) and x-ray, etc.) used in metrology tools (e.g., a scatterometer, optical tools, SEM, etc.).

The patterning device can comprise, or can form, one or more design layouts. The design layout can be generated utilizing CAD (computer-aided design) programs, this process often being referred to as EDA (electronic design automation). Most CAD programs follow a set of predetermined design rules in order to create functional design layouts/patterning devices. These rules are set by processing and design limitations. For example, design rules define the space tolerance between devices (such as gates, capacitors, etc.) or interconnect lines, so as to ensure that the devices or lines do not interact with one another in an undesirable way. One or more of the design rule limitations may be referred to as “critical dimension” (CD). A critical dimension of a device can be defined as the smallest width of a line or hole or the smallest space between two lines or two holes. Thus, the CD determines the overall size and density of the designed device. Of course, one of the goals in device fabrication is to faithfully reproduce the original design intent on the substrate (via the patterning device).

The term “mask” or “patterning device” as employed in this text may be broadly interpreted as referring to a generic patterning device that can be used to endow an incoming radiation beam with a patterned cross-section, corresponding to a pattern that is to be created in a target portion of the substrate; the term “light valve” can also be used in this context. Besides the classic mask (transmissive or reflective; binary, phase-shifting, hybrid, etc.), examples of other such patterning devices include a programmable mirror array and a programmable LCD array.

An example of a programmable mirror array can be a matrix-addressable surface having a viscoelastic control layer and a reflective surface. The basic principle behind such an apparatus is that (for example) addressed areas of the reflective surface reflect incident radiation as diffracted radiation, whereas unaddressed areas reflect incident radiation as undiffracted radiation. Using an appropriate filter, the said undiffracted radiation can be filtered out of the reflected beam, leaving only the diffracted radiation behind; in this manner, the beam becomes patterned according to the addressing pattern of the matrix-addressable surface. The required matrix addressing can be performed using suitable electronic means.

An example of a programmable LCD array is given in U.S. Pat. No. 5,229,872, which is incorporated herein by reference.

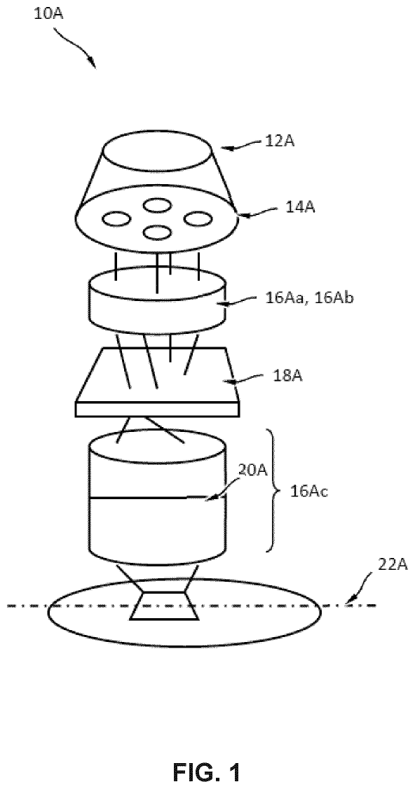

FIG. 1 illustrates a block diagram of various subsystems of a lithographic projection apparatus 10A, according to an embodiment. Major components are a radiation source 12A, which may be a deep-ultraviolet excimer laser source or other type of source including an extreme ultra violet (EUV) source (as discussed above, the lithographic projection apparatus itself need not have the radiation source), illumination optics which, e.g., define the partial coherence (denoted as sigma) and which may include optics 14A, 16Aa and 16Ab that shape radiation from the source 12A; a patterning device 18A; and transmission optics 16Ac that project an image of the patterning device pattern onto a substrate plane 22A. An adjustable filter or aperture 20A at the pupil plane of the projection optics may restrict the range of beam angles that impinge on the substrate plane 22A, where the largest possible angle defines the numerical aperture of the projection optics NA=n sin(Θₘₐₓ), wherein n is the refractive index of the media between the substrate and the last element of the projection optics, and Θₘₐₓ is the largest angle of the beam exiting from the projection optics that can still impinge on the substrate plane 22A.

In a lithographic projection apparatus, a source provides illumination (i.e. radiation) to a patterning device and projection optics direct and shape the illumination, via the patterning device, onto a substrate. The projection optics may include at least some of the components 14A, 16Aa, 16Ab and 16Ac. An aerial image (AI) is the radiation intensity distribution at substrate level. A resist model can be used to calculate the resist image from the aerial image, an example of which can be found in U.S. Patent Application Publication No. US 2009-0157630, the disclosure of which is hereby incorporated by reference in its entirety. The resist model is related only to properties of the resist layer (e.g., effects of chemical processes which occur during exposure, post-exposure bake (PEB) and development). Optical properties of the lithographic projection apparatus (e.g., properties of the illumination, the patterning device and the projection optics) dictate the aerial image and can be defined in an optical model. Since the patterning device used in the lithographic projection apparatus can be changed, it is desirable to separate the optical properties of the patterning device from the optical properties of the rest of the lithographic projection apparatus including at least the source and the projection optics. Details of techniques and models used to transform a design layout into various lithographic images (e.g., an aerial image, a resist image, etc.), apply OPC using those techniques and models and evaluate performance (e.g., in terms of process window) are described in U.S. Patent Application Publication Nos. US 2008-0301620, 2007-0050749, 2007-0031745, 2008-0309897, 2010-0162197, and 2010-0180251, the disclosure of each which is hereby incorporated by reference in its entirety.

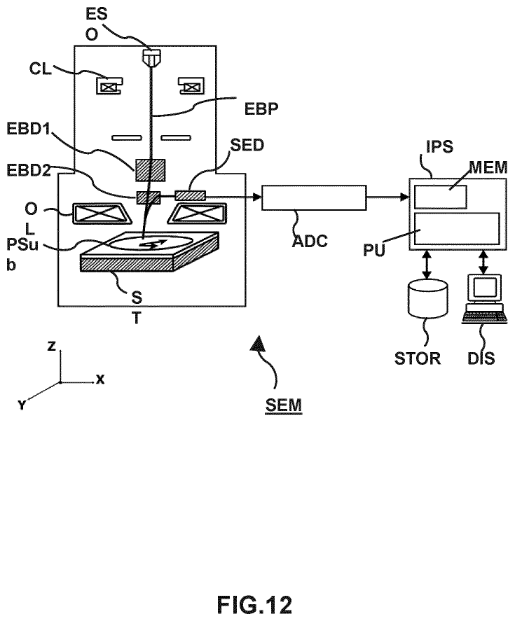

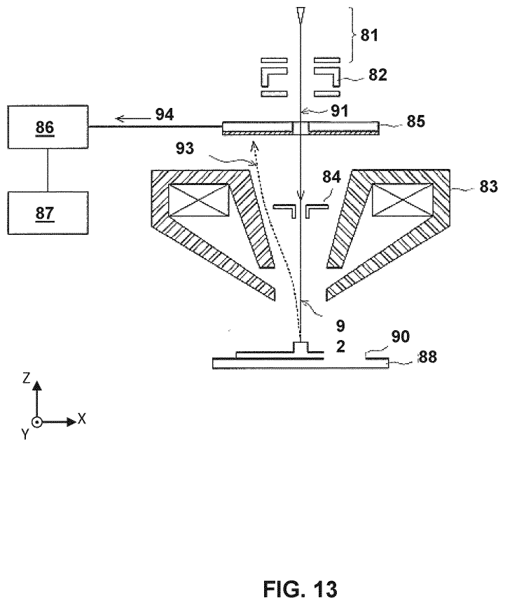

A semiconductor manufacturing step up comprises lithography apparatus, an inspection apparatus, or other devices that a vacuum environment to be maintained during operation. In an example setup, there may be several vacuum pumps (e.g., turbo pumps) installed on multi-beam inspection (MBI) platform to generate a deep vacuum (e.g., up to E-7 torr level) environment in a main chamber of MBI. These vacuum pumps have a rotor inside that rotates at very high speed (e.g., up to 60,000 rpm) and therefore contains very high kinetic energy. These vacuum pumps are considered as a vibration source. The vibrations get transferred to the main chamber or the surrounding systems. As such, a vacuum pump is installed with a vibration isolator to isolate vibrations of the vacuum pump from the main chamber (considered as a quiet world), for example. Example of working of a scanning electron microscope and inspection apparatus are discussed with respect to FIGS. 12 and 13.

As mentioned earlier, the vacuum pump (e.g., a turbo pump) may malfunction and cause catastrophic failure. For example, the pump may catastrophically fail due to inside rotor crashing and generate up to 100,000 Nm burst torque. The vibration isolator comprises just a flexible thin-wall bellow with rubber damping material. As such, the vibration isolator can easily get damaged and does not provide sufficient safety mechanism. Hence, people or components around pumps may get injured or damaged during a pump malfunction or catastrophic failure. For example, cables and hoses connected to the turbo pumps may swing out to injure people due to rapid rotation of the vacuum pump housing if rotor inside gets jammed with housing. In another example, the vacuum pump can rip off the isolator bellow and fly out to injure people.

Existing technology, does not provide any protection solution for such malfunction events while considering the pump safety and vibration performance at the same time. In some applications, the vacuum pump do not require the vibration isolator and the vacuum pump is firmly mounted to solid chamber. So, the safety relies on screw strength and mounting interface strength used for mounting. In some application, the vacuum pump may be installed on the vibration isolator. Currently, the access area of the vacuum pump is restricted to minimize the damage.

In some applications, fixing the vacuum pump on the chamber may solve the safety issue, but the vacuum pump is directly connected to the chamber and consequently transferring vibration to the chamber. Hence, such solution is not applicable for the applications where vibration specification is important. Restricting the access area of the vacuum pumps cannot fully resolve human safety issue because the debris can still fly out. Furthermore, such solutions not only limit volume usage but also cause further damage to surrounding components in an event of malfunction due to the fact that there is very limited restriction on the pump movement. It is not a safe solution for both human and machine.

The present disclosure provides a safety mechanism attachable to a vacuum system including a vacuum pump (e.g., a turbo pump). The safety mechanism limits displacement of a vacuum pump housing during a pump catastrophic crash, for example. Also, the safety mechanism absorbs the kinetic energy of a malfunctioning or crashed vacuum pump, for example. The present disclosure provides mitigating of the safety risk during a pump malfunction while keeping normal operating performance. The mechanism herein confines displacement of the vacuum pump housing during a pump malfunction while not negatively affecting vibration isolation performance during normal operation. Also, the mechanism provides for absorbing the kinetic energy of the pump malfunction while minimizing the damage to parts other than protection structures, the vibration isolator and the pump.

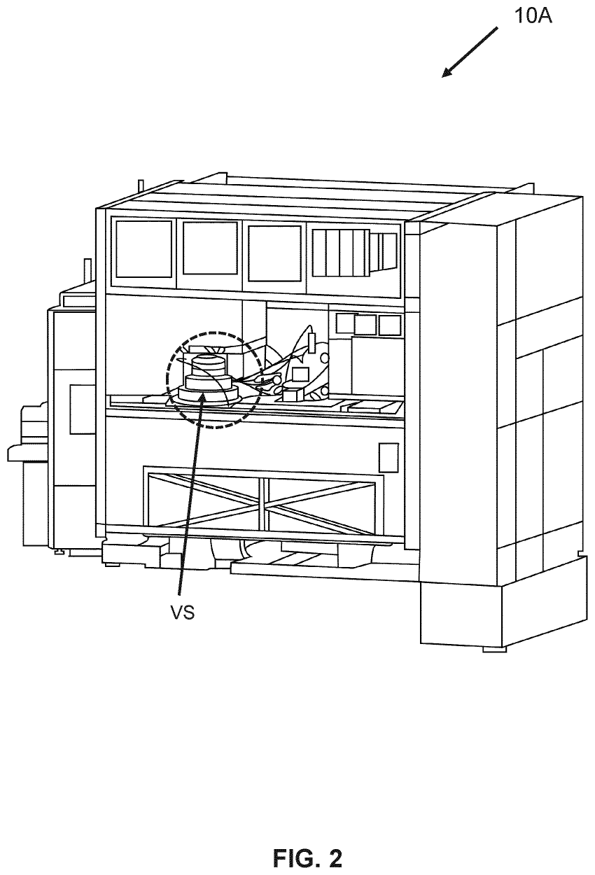

FIG. 2 shows an exemplary lithography apparatus 10A including a vacuum system VS used in a multi-beam inspection system. The vacuum system VS includes a pump (or vacuum pump) and a vibration isolator (not explicitly illustrated). The pump creates vacuum inside a chamber on which the pump is mounted. The vacuum can be used to create a vacuum environment in which a substrate may be placed.

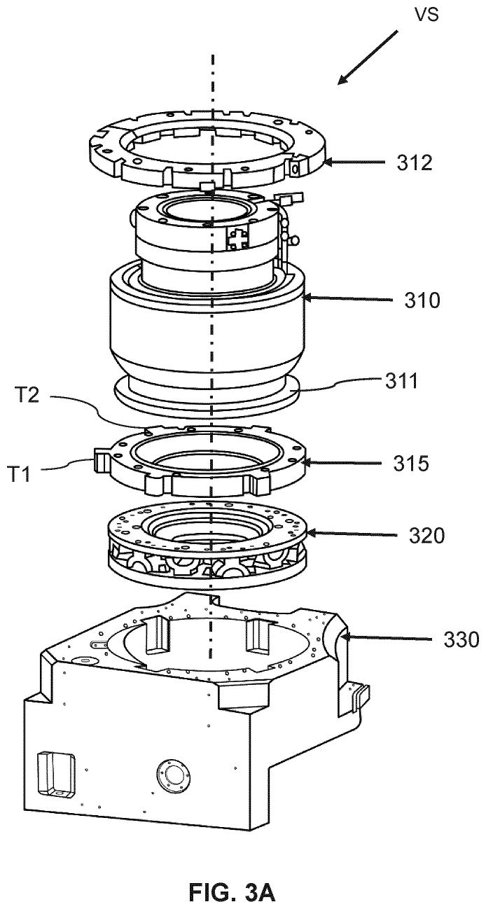

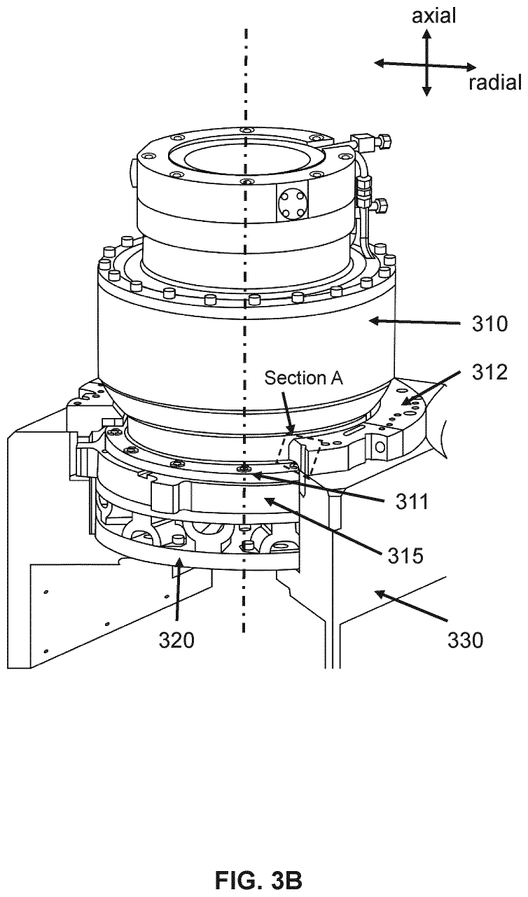

FIG. 3A is an exploded view of a vacuum system VS and FIG. 3B is an assembly view of the vacuum system VS. The vacuum system VS includes a vacuum pump 310 (e.g., a turbo pump), a vibration isolator 320, and a mounting chamber 330. In the Figures herein, the vacuum pump 310 is interchangeably referred as a vacuum pump housing 310. Typically, inside the housing 310 several components are assembled together, e.g., a rotor and gears mounted on a shaft that cause vibrations during operation.

As shown in FIG. 3B, the vacuum pump 310 is coupled to the vibration isolator 320. In an embodiment, the mounting chamber 330 comprises a pocket to receive the vibration isolator 320 and/or a stop structure 315 (discussed in more detail later in the disclosure). The vibration isolator 320 inhibits transmission of vibrations from the vacuum pump housing 310 to the chamber 330 within which a vacuum environment is maintained. According to the present disclosure, the vacuum system VS includes one or more components configured to limit displacement of the vacuum pump 310 in case of a malfunction, e.g., when a pump housing moves beyond a threshold amount. For example, the malfunction can be an imbalance caused in rotation shaft, which may lead to rotational or axial displacement of the pump housing, eventually causing the pump to displace above a design specification (a threshold amount) with respect to a mounting chamber 330, for example. In an embodiment, the threshold amount can be indicative of a failure condition. When the vacuum pump moves beyond the specification, it may eventually lead to the vacuum pump failure. Upon failure, for example the pump components may fly off in different directions. As such, the displacement of the pump housing is limited herein via one or more stop structures.

In an embodiment, there is provided a stop structure to limit a rotational displacement of the vacuum pump 310. In an embodiment, the stop structure may be a separate structure that is fixedly connected to the pump housing 310. For example, the stop structure may be configured to be coupled to a flange of the pump housing 310. In another example, the stop structure may be configured to be coupled to a circumference of the pump housing 310. In an embodiment, the stop structure may be integral to the pump housing 310.

In an embodiment, the stop structure (a first component) is disposed between the vacuum pump housing 310 and an adjacent fixture (a second component) coupled to a rigid structure. The stop structure in cooperation with the adjacent fixture prevents displacement of the vacuum pump housing 310 relative to the fixture above a threshold amount. During normal operation, the displacement of the vacuum pump housing 310 is configured to be within the threshold amount (e.g., indicative of a potential start of a malfunction). The fixture can be a separate component or integral with the mounting chamber 330. In an embodiment, the rigid structure is the mounting chamber 330. The fixture (second component) is coupled to the rigid structure and isolated from the pump by being separated from the pump. The separation preventing vibration of the pump 310 from being transmitted to the rigid structure via the fixture.

The stop structure is configured to contact the fixture, which in cooperation with the rigid structure prevents displacement of the vacuum pump housing above the threshold amount in the event of a malfunction of the vacuum pump. An exemplary stop structure 315 is discussed in detail with respect to FIGS. 3A-3B, 4A-4C and 5A-5B.

FIGS. 3A and 3B illustrates an exemplary stop structure 315 configured to limit the displacement of the vacuum pump housing 310. In some embodiment, the stop structure 315 is fixed to the vacuum pump 310, for example, at the flange 311. The stop structure 315 can be fixedly attached by screws disposed around the flange 311 of the housing 310. As shown in FIG. 3B, the stop structure 315 is disposed between the vacuum pump 310 and the vibration isolator 320 and fixedly coupled to the vacuum pump 310 and the vibration isolator 320. However, as mentioned earlier, positioning of the stop structure 315 is not limited to be between the pump 310 and the vibration isolator 320. In some embodiment, the pump 310 may be directly coupled to the vibration isolator 320 and the stop structure may be coupled at other appropriate location on the pump housing 310.

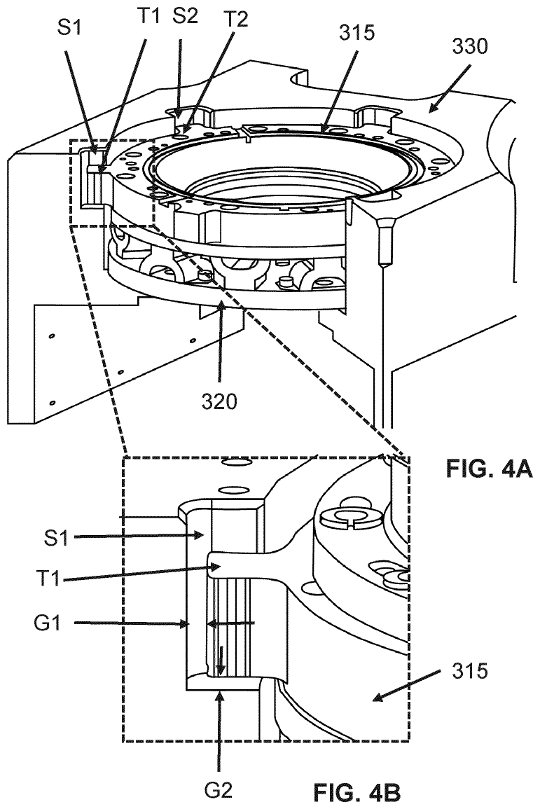

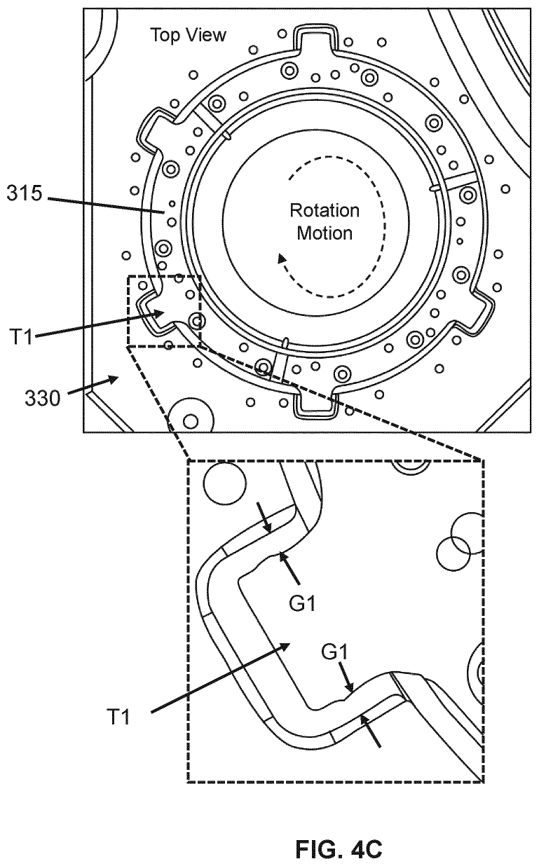

In the present example, the stop structure 315 has protruding structures that serves as an engage mechanism with a fixture during rotation motion. The protruding structures comprise a gear-like structure having a plurality of teeth (e.g., teeth T1 and T2). The labelling of protruding structures e.g., teeth T1 and T2 are exemplary and all teeth are not marked herein for better visibility in Figures. The protruding structures substantially conform to the fixture coupled to a rigid structure such as the mounting chamber 330 (see FIGS. 3B and 4A). When the stop structure 315 rotates with the vacuum pump 310, the gear teeth (e.g., T1 and T2) will engage with the fixture consequently stopping the motion of the pump 310. In the present example, the fixture is part of the chamber 330. In an embodiment, the fixture can be a separate rigid component placed outside or away from the chamber 330.

The fixture is isolated from the pump 310 by being separated from the pump 310, the isolation preventing vibration of the pump 310 from being transmitted to the chamber 330. For example, the stop structure 315 is normally spaced from the chamber 330 and does not contact the chamber 330 during normal operation of the vacuum pump 310. The chamber 330 includes depressions or slots (e.g., S1 and S2 in FIG. 4A) that correspond to the protruding structures (e.g., teeth T1 and T2 in FIG. 4A), where corresponding protrusion/depression pairs prevent the pump from rotating around a central axis beyond a predetermined amount.

FIGS. 4B, and 4C illustrates the spacing such as small gaps G1 and G2 between the stop structure 315 and the fixture (e.g., the chamber 330, in this example) to avoid contact between the vacuum pump 310 and the chamber 330. FIG. 4B is a cross-section view showing gap G1 maintain between the edge of the tooth T1 and the slot S1. As shown, FIGS. 4B and 4C, the gap G1 is maintained in a radial direction between the protruding structures and the mounting chamber 330. FIG. 4C is a top view of the stop structure 315 and a magnified view of a portion of the vacuum pump showing gaps between the tooth T1 and slot S1. In an embodiment, the gap G1 between different surfaces may be same or unequal. The gap G2 is maintained in an axial direction between the bottom of the tooth T1 and a surface of the chamber 330. As such, an envelope of spacing is created between the stop structure 315 and the chamber 330. Consequently, no vibration is transferred to the chamber 330 during normal operation of the vacuum pump 310. The small gaps G1 and G2 can also avoid severe impact between surrounding parts by limiting speed building up from the moving parts when the vacuum pump malfunction/crash occurs.

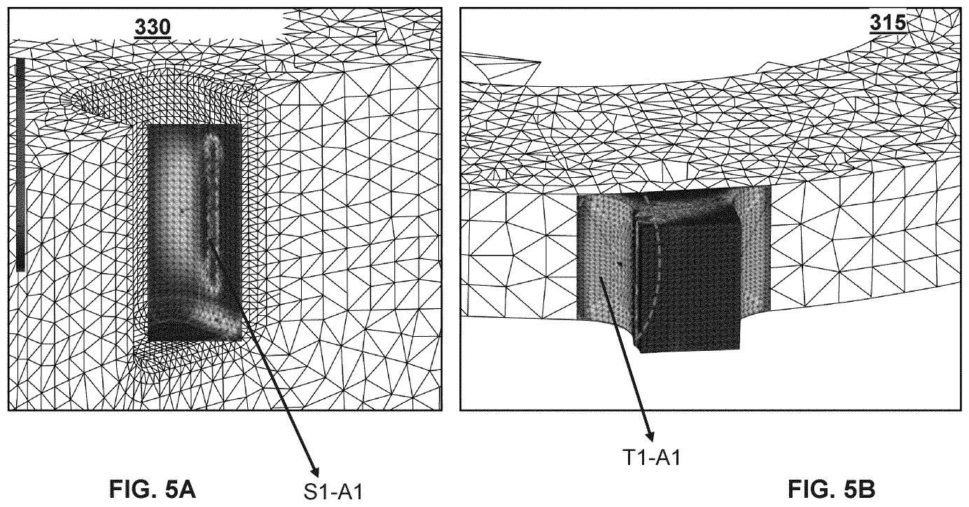

While limiting the speed buildup, protruding structures such as the teeth T1 and T2 can also absorb the kinetic energy of the vacuum pump 310, as illustrated in FIG. 5B. For example, plastic deformation regions T1-A1 at an end of the tooth T1 absorb the kinetic energy in an event of a pump malfunction. In an embodiment, protruding structures are made of softer material (e.g., copper, steel, or other softer material than e.g., cast iron) compared to the material of the chamber 330. As such, referring to FIG. 5A, the slot S1 of the chamber 330 has substantially less or no deformation upon contact (e.g., at S1-A1) with the protruding structures e.g., tooth T1. Hence, minimal or no damage is done to the chamber 330. As mentioned earlier, the fixture comprising the slots (e.g., S1) is part of the chamber 330. In another example, the fixture may be separate (e.g., an insert with slots) that can be removeably attached to the chamber 330. In an embodiment, damage to the fixture or mounting chamber 330 is not desirable as such the fixture may be made of material such as cast iron and the protruding structures may be made of softer material such as copper. In an embodiment, only the protruding structure of the stop structure 315 may be of the softer material or the entire stop structure 315 can be of the softer material.

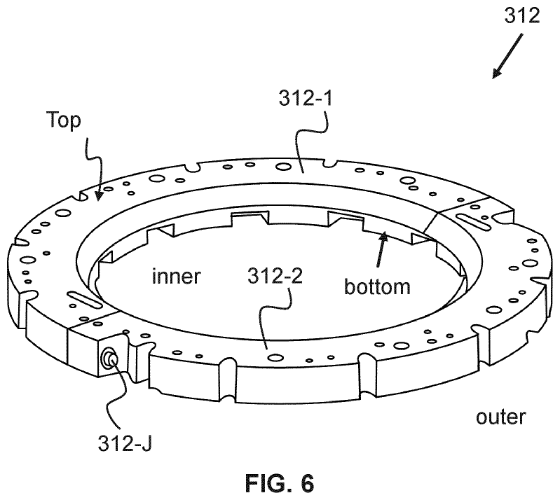

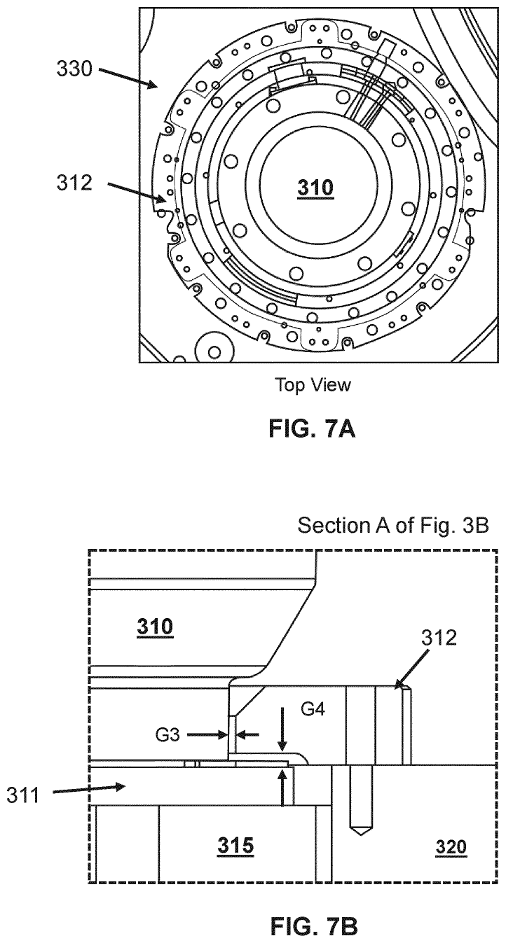

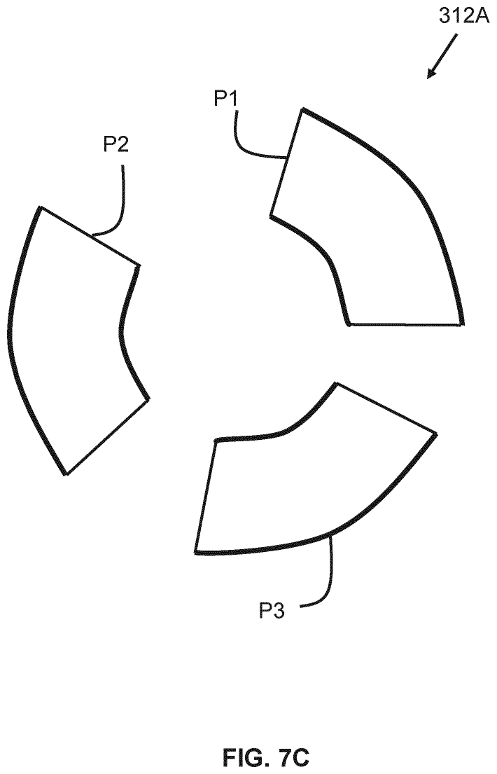

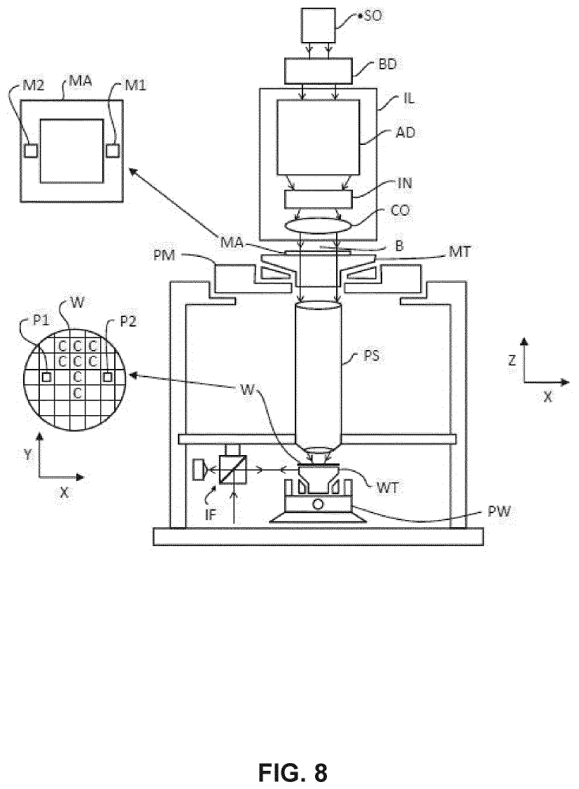

In an embodiment, upon malfunction of the pump 310, the pump may be displaced along a central axis of the vacuum pump 310. Hence, according to an embodiment, there is provided a third component referred as a collar 312 (e.g., see FIGS. 3A and 3B) to limit an axial displacement of the vacuum pump 310. The collar 312 is configured to prevent displacement of the vacuum pump housing 310 along the axis of rotation of the vacuum pump above an axial threshold amount. The displacement of the vacuum pump housing 310 is configured to be within the axial threshold amount during normal operation. An exemplary collar is discussed in detail with respect to FIGS. 6 and 7A-7B.

The collar 312 is attached to a fixed structure (e.g., the chamber 330). The collar 312 may fully or partially cover the vacuum pump housing 310. If the vacuum pump 310 has axial motion, it will hit the collar 312 and the motion will be restricted in a limited area (e.g., within spacing therebetween).

FIG. 6 shows an isometric view of the exemplary collar 312 having a ring like structure, and FIG. 7A is a top view of the collar 312 placed around the vacuum pump 310. The collar 312 comprises a first portion 312-1; and a second portion 312-2. The second portion 312-2 configured to couple with the first portion 312-1 forming a ring, the first portion 312-1 and the second portion 312-2 configured to be attached (e.g., at 312-J) around a circumference of the vacuum pump 310. The first and second portions may be coupled together via a fastening mechanism such as a screw provided at a joint 312-J. As such, the collar 312 can be easily assembled and removed as desired. For example, after a malfunction the collar 312 may be damage (e.g., bend) and may need replacement. The two portion structure allows easy removal and assembly without removing the pump itself. However, the collar 312 structure is exemplary and not limited to two portions. A person of ordinary skill in the art may design the collar as a single component (depending on the shape of the housing at which the collar will be assembled), or more than two portions that can be coupled to each other. In an embodiment, the two portions, three portions, etc., may be spaced from each other and may not be coupled to each other.

In an embodiment, the collar 312 is normally spaced from the vacuum pump 310 and the vibration isolator 320 during operation of the vacuum pump 310. In an embodiment, the collar 312 is attached at a flange of the vacuum pump 310 while maintaining the spacing therebetween. As shown, the collar 312 also has recess at the bottom side of the collar 312. These recess may be provided to prevent contacting any bumps or screws that may be present on the flange surface, for example. Additionally, a top surface of the collar 312 may be profiled to conform with the surface of the vacuum pump housing 310 at which the collar 312 is attached.

In an embodiment, the collar 312 is fixedly attached (e.g., using fasteners such as screws) to the mounting chamber 330 (quiet world with low vibration specification). The collar 312 is not directly coupled to the vacuum pump housing 310 and maintains a spacing (gap) between the collar 312 and the pump housing 310. When the vacuum pump 310 moves axially, the collar 312 will stop the motion by holding the vacuum pump flange 311 motion within the gap.

FIG. 7B is a cross-section of a section A (of FIG. 3B) illustrating an assembly of the collar 312 with other components of the vacuum system VS. As shown in FIG. 7B, the collar 312 is attached to the mounting chamber 330 while maintaining gaps G3 and G4 between the collar and surrounding components. The gap G3 is maintained in a radial direction between a circumferential surface of the pump housing 310 and the inner circumference of the collar 312. The gap G4 is maintained in an axial direction between a bottom surface of the collar 312 and the top surface of the flange 311 of the vacuum pump housing 310. Thus, a spacing envelope is created between surfaces of the vacuum pump housing 310 and collar 312. During normal conditions, these small gaps G3 and G4 ensure the collar 312 not to touch the vacuum pump 310 (considered as vibration source). Therefore, no vibration is transferred from the vacuum pump 310 to the area with low vibration requirement.

The collar 312 discussed herein is exemplary and is not limited to shape, size and number of portions. In an embodiment, the collar may comprises one or more portions attached to a fixed structure (e.g., the chamber 330), and shaped to conform with circumferential shape of the vacuum pump housing. In an embodiment, two or more portion may be connected to each other to form a ring structure. In an embodiment, the two or more may be separated from each other in angular manner. For example, referring to FIG. 7C, the collar 312A includes a first component P1 may be spread from 0-60°, the second component P2 may be spread from 120° to 180°, and a third component P3 may be spread from 270°-330° around the flange of the pump housing 310 (not illustrated in FIG. 7C). FIG. 7C is provided for illustration purposes to show an example variation of the collar 312. The profile, cross-section, shape, or other geometrical feature may be similar to the collar 312 illustrates and discussed with respect to FIGS. 7A and 7B, for example.

The vacuum system discussed herein is only exemplary to illustrate several concepts of the present disclosure, and does not limit the scope of the present disclosure. For example, the vacuum system can be any system including a pump that is used to create a vacuum environment, or other pump functions related to the pump that leads to pump failure. The terms “pump,” and “vacuum pump,” are used interchangeably and does not limit the present disclosure to a particular type of pump (e.g., a turbo pump).

FIG. 8 is a schematic diagram of a lithographic projection apparatus, according to an embodiment.

The lithographic projection apparatus can include an illumination system IL, a first object table MT, a second object table WT, and a projection system PS.

Illumination system IL, can condition a beam B of radiation. In this particular case, the illumination system also comprises a radiation source SO.

First object table (e.g., patterning device table) MT can be provided with a patterning device holder to hold a patterning device MA (e.g., a reticle), and connected to a first positioner to accurately position the patterning device with respect to item PS.

Second object table (substrate table) WT can be provided with a substrate holder to hold a substrate W (e.g., a resist-coated silicon wafer), and connected to a second positioner to accurately position the substrate with respect to item PS.

Projection system (“lens”) PS (e.g., a refractive, catoptric or catadioptric optical system) can image an irradiated portion of the patterning device MA onto a target portion C (e.g., comprising one or more dies) of the substrate W.

As depicted herein, the apparatus can be of a transmissive type (i.e., has a transmissive patterning device). However, in general, it may also be of a reflective type, for example (with a reflective patterning device). The apparatus may employ a different kind of patterning device to classic mask; examples include a programmable mirror array or LCD matrix.

The source SO (e.g., a mercury lamp or excimer laser, LPP (laser produced plasma) EUV source) produces a beam of radiation. This beam is fed into an illumination system (illuminator) IL, either directly or after having traversed conditioning means, such as a beam expander Ex, for example. The illuminator IL may comprise adjusting means AD for setting the outer and/or inner radial extent (commonly referred to as σ-outer and σ-inner, respectively) of the intensity distribution in the beam. In addition, it will generally comprise various other components, such as an integrator IN and a condenser CO. In this way, the beam B impinging on the patterning device MA has a desired uniformity and intensity distribution in its cross-section.

In some embodiments, source SO may be within the housing of the lithographic projection apparatus (as is often the case when source SO is a mercury lamp, for example), but that it may also be remote from the lithographic projection apparatus, the radiation beam that it produces being led into the apparatus (e.g., with the aid of suitable directing mirrors); this latter scenario can be the case when source SO is an excimer laser (e.g., based on KrF, ArF or F2 lasing).

The beam PB can subsequently intercept patterning device MA, which is held on a patterning device table MT. Having traversed patterning device MA, the beam B can pass through the lens PL, which focuses beam B onto target portion C of substrate W. With the aid of the second positioning means (and interferometric measuring means IF), the substrate table WT can be moved accurately, e.g. so as to position different target portions C in the path of beam PB. Similarly, the first positioning means can be used to accurately position patterning device MA with respect to the path of beam B, e.g., after mechanical retrieval of the patterning device MA from a patterning device library, or during a scan. In general, movement of the object tables MT, WT can be realized with the aid of a long-stroke module (coarse positioning) and a short-stroke module (fine positioning). However, in the case of a stepper (as opposed to a step-and-scan tool) patterning device table MT may just be connected to a short stroke actuator, or may be fixed.

The depicted tool can be used in two different modes, step mode and scan mode. In step mode, patterning device table MT is kept essentially stationary, and an entire patterning device image is projected in one go (i.e., a single “flash”) onto a target portion C. Substrate table WT can be shifted in the x and/or y directions so that a different target portion C can be irradiated by beam PB.

In scan mode, essentially the same scenario applies, except that a given target portion C is not exposed in a single “flash.” Instead, patterning device table MT is movable in a given direction (the so-called “scan direction”, e.g., the y direction) with a speed v, so that projection beam B is caused to scan over a patterning device image; concurrently, substrate table WT is simultaneously moved in the same or opposite direction at a speed V=Mv, in which M is the magnification of the lens PL (typically, M=¼ or ⅕). In this manner, a relatively large target portion C can be exposed, without having to compromise on resolution.

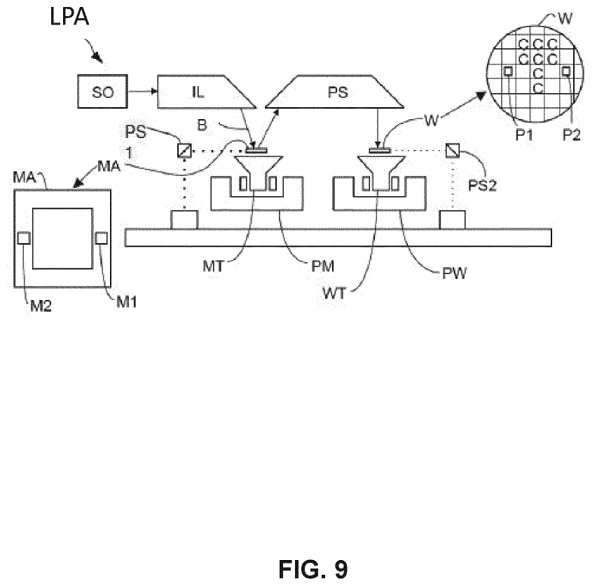

FIG. 9 is a schematic diagram of another lithographic projection apparatus (LPA), according to an embodiment.

LPA can include source collector module SO, illumination system (illuminator) IL configured to condition a radiation beam B (e.g. EUV radiation), support structure MT, substrate table WT, and projection system PS.

Support structure (e.g. a patterning device table) MT can be constructed to support a patterning device (e.g. a mask or a reticle) MA and connected to a first positioner PM configured to accurately position the patterning device;

Substrate table (e.g. a wafer table) WT can be constructed to hold a substrate (e.g. a resist coated wafer) W and connected to a second positioner PW configured to accurately position the substrate.

Projection system (e.g. a reflective projection system) PS can be configured to project a pattern imparted to the radiation beam B by patterning device MA onto a target portion C (e.g. comprising one or more dies) of the substrate W.

As here depicted, LPA can be of a reflective type (e.g. employing a reflective patterning device). It is to be noted that because most materials are absorptive within the EUV wavelength range, the patterning device may have multilayer reflectors comprising, for example, a multi-stack of molybdenum and silicon. In one example, the multi-stack reflector has a 40 layer pairs of molybdenum and silicon where the thickness of each layer is a quarter wavelength. Even smaller wavelengths may be produced with X-ray lithography. Since most material is absorptive at EUV and x-ray wavelengths, a thin piece of patterned absorbing material on the patterning device topography (e.g., a TaN absorber on top of the multi-layer reflector) defines where features would print (positive resist) or not print (negative resist).

Illuminator IL can receive an extreme ultra violet radiation beam from source collector module SO. Methods to produce EUV radiation include, but are not necessarily limited to, converting a material into a plasma state that has at least one element, e.g., xenon, lithium or tin, with one or more emission lines in the EUV range. In one such method, often termed laser produced plasma (“LPP”) the plasma can be produced by irradiating a fuel, such as a droplet, stream or cluster of material having the line-emitting element, with a laser beam. Source collector module SO may be part of an EUV radiation system including a laser, not shown in FIG. 9, for providing the laser beam exciting the fuel. The resulting plasma emits output radiation, e.g., EUV radiation, which is collected using a radiation collector, disposed in the source collector module. The laser and the source collector module may be separate entities, for example when a CO2 laser is used to provide the laser beam for fuel excitation.

In such cases, the laser may not be considered to form part of the lithographic apparatus and the radiation beam can be passed from the laser to the source collector module with the aid of a beam delivery system comprising, for example, suitable directing mirrors and/or a beam expander. In other cases, the source may be an integral part of the source collector module, for example when the source is a discharge produced plasma EUV generator, often termed as a DPP source.

Illuminator IL may comprise an adjuster for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may comprise various other components, such as facetted field and pupil mirror devices. The illuminator may be used to condition the radiation beam, to have a desired uniformity and intensity distribution in its cross section.

The radiation beam B can be incident on the patterning device (e.g., mask) MA, which is held on the support structure (e.g., patterning device table) MT, and is patterned by the patterning device. After being reflected from the patterning device (e.g. mask) MA, the radiation beam B passes through the projection system PS, which focuses the beam onto a target portion C of the substrate W. With the aid of the second positioner PW and position sensor PS2 (e.g. an interferometric device, linear encoder or capacitive sensor), the substrate table WT can be moved accurately, e.g. so as to position different target portions C in the path of radiation beam B. Similarly, the first positioner PM and another position sensor PS1 can be used to accurately position the patterning device (e.g. mask) MA with respect to the path of the radiation beam B. Patterning device (e.g. mask) MA and substrate W may be aligned using patterning device alignment marks M1, M2 and substrate alignment marks P1, P2.

The depicted apparatus LPA could be used in at least one of the following modes, step mode, scan mode, and stationary mode.

In step mode, the support structure (e.g. patterning device table) MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed.

In scan mode, the support structure (e.g. patterning device table) MT and the substrate table WT are scanned synchronously while a pattern imparted to the radiation beam is projected onto target portion C (i.e. a single dynamic exposure). The velocity and direction of substrate table WT relative to the support structure (e.g. patterning device table) MT may be determined by the (de-)magnification and image reversal characteristics of the projection system PS.

In stationary mode, the support structure (e.g. patterning device table) MT is kept essentially stationary holding a programmable patterning device, and substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

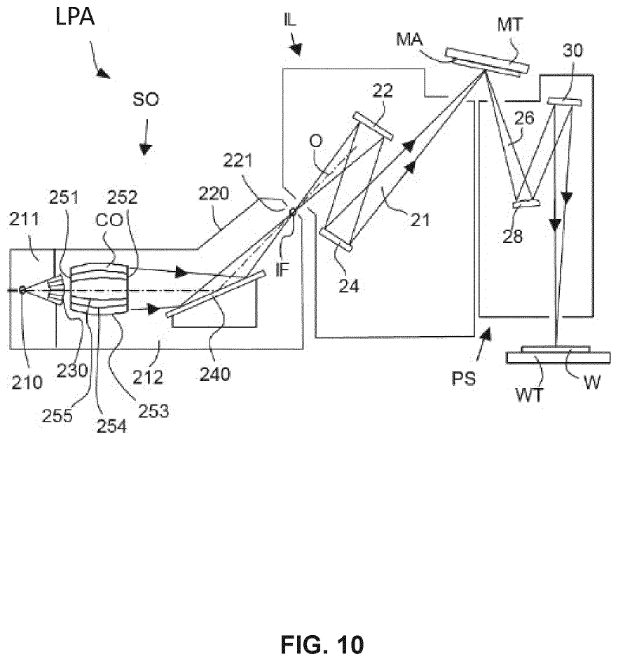

FIG. 10 is a detailed view of the lithographic projection apparatus, according to an embodiment.

As shown, LPA can include the source collector module SO, the illumination system IL, and the projection system PS. The source collector module SO is constructed and arranged such that a vacuum environment can be maintained in an enclosing structure 220 of the source collector module SO. An EUV radiation emitting plasma 210 may be formed by a discharge produced plasma source. EUV radiation may be produced by a gas or vapor, for example Xe gas, Li vapor or Sn vapor in which the very hot plasma 210 is created to emit radiation in the EUV range of the electromagnetic spectrum. The very hot plasma 210 is created by, for example, an electrical discharge causing at least partially ionized plasma. Partial pressures of, for example, 10 Pa of Xe, Li, Sn vapor or any other suitable gas or vapor may be required for efficient generation of the radiation. In an embodiment, a plasma of excited tin (Sn) is provided to produce EUV radiation.

The radiation emitted by the hot plasma 210 is passed from a source chamber 211 into a collector chamber 212 via an optional gas barrier or contaminant trap 230 (in some cases also referred to as contaminant barrier or foil trap) which is positioned in or behind an opening in source chamber 211. The contaminant trap 230 may include a channel structure. Contamination trap 230 may also include a gas barrier or a combination of a gas barrier and a channel structure. The contaminant trap or contaminant barrier 230 further indicated herein at least includes a channel structure, as known in the art.

The collector chamber 211 may include a radiation collector CO which may be a so-called grazing incidence collector. Radiation collector CO has an upstream radiation collector side 251 and a downstream radiation collector side 252. Radiation that traverses collector CO can be reflected off a grating spectral filter 240 to be focused in a virtual source point IF along the optical axis indicated by the dot-dashed line ‘O’. The virtual source point IF is commonly referred to as the intermediate focus, and the source collector module is arranged such that the intermediate focus IF is located at or near an opening 221 in the enclosing structure 220. The virtual source point IF is an image of the radiation emitting plasma 210.

Subsequently the radiation traverses the illumination system IL, which may include a facetted field mirror device 22 and a facetted pupil mirror device 24 arranged to provide a desired angular distribution of the radiation beam 21, at the patterning device MA, as well as a desired uniformity of radiation intensity at the patterning device MA. Upon reflection of the beam of radiation 21 at the patterning device MA, held by the support structure MT, a patterned beam 26 is formed and the patterned beam 26 is imaged by the projection system PS via reflective elements 28, 30 onto a substrate W held by the substrate table WT.

More elements than shown may generally be present in illumination optics unit IL and projection system PS. The grating spectral filter 240 may optionally be present, depending upon the type of lithographic apparatus. Further, there may be more mirrors present than those shown in the figures, for example there may be 1-6 additional reflective elements present in the projection system PS than shown in FIG. 10.

Collector optic CO, as illustrated in FIG. 10, is depicted as a nested collector with grazing incidence reflectors 253, 254 and 255, just as an example of a collector (or collector mirror). The grazing incidence reflectors 253, 254 and 255 are disposed axially symmetric around the optical axis O and a collector optic CO of this type may be used in combination with a discharge produced plasma source, often called a DPP source.

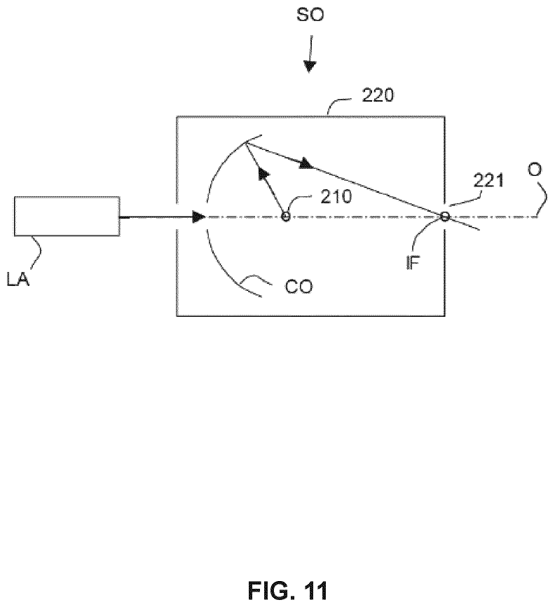

FIG. 11 is a detailed view of source collector module SO of lithographic projection apparatus LPA, according to an embodiment.

Source collector module SO may be part of an LPA radiation system. A laser LA can be arranged to deposit laser energy into a fuel, such as xenon (Xe), tin (Sn) or lithium (Li), creating the highly ionized plasma 210 with electron temperatures of several 10's of eV. The energetic radiation generated during de-excitation and recombination of these ions is emitted from the plasma, collected by a near normal incidence collector optic CO and focused onto the opening 221 in the enclosing structure 220.

The concepts disclosed herein may simulate or mathematically model any generic imaging system for imaging sub wavelength features, and may be especially useful with emerging imaging technologies capable of producing increasingly shorter wavelengths. Emerging technologies already in use include EUV (extreme ultra violet), DUV lithography that is capable of producing a 193 nm wavelength with the use of an ArF laser, and even a 157 nm wavelength with the use of a Fluorine laser. Moreover, EUV lithography is capable of producing wavelengths within a range of 20-50 nm by using a synchrotron or by hitting a material (either solid or a plasma) with high energy electrons in order to produce photons within this range.

In some embodiments, the inspection apparatus or the metrology tool may be a scanning electron microscope (SEM) that yields an image of a structure (e.g., some or all the structure of a device) exposed or transferred on the substrate. FIG. 12 depicts an embodiment of a SEM tool. A primary electron beam EBP emitted from an electron source ESO is converged by condenser lens CL and then passes through a beam deflector EBD1, an E×B deflector EBD2, and an objective lens OL to irradiate a substrate PSub on a substrate table ST at a focus.

When the substrate PSub is irradiated with electron beam EBP, secondary electrons are generated from the substrate PSub. The secondary electrons are deflected by the E×B deflector EBD2 and detected by a secondary electron detector SED. A two-dimensional electron beam image can be obtained by detecting the electrons generated from the sample in synchronization with, e.g., two dimensional scanning of the electron beam by beam deflector EBD1 or with repetitive scanning of electron beam EBP by beam deflector EBD1 in an X or Y direction, together with continuous movement of the substrate PSub by the substrate table ST in the other of the X or Y direction.

A signal detected by secondary electron detector SED is converted to a digital signal by an analog/digital (A/D) converter ADC, and the digital signal is sent to an image processing system IPU. In an embodiment, the image processing system IPU may have memory MEM to store all or part of digital images for processing by a processing unit PU. The processing unit PU (e.g., specially designed hardware or a combination of hardware and software) is configured to convert or process the digital images into datasets representative of the digital images. Further, image processing system IPU may have a storage medium STOR configured to store the digital images and corresponding datasets in a reference database. A display device DIS may be connected with the image processing system IPU, so that an operator can conduct necessary operation of the equipment with the help of a graphical user interface.

As noted above, SEM images may be processed to extract contours that describe the edges of objects, representing device structures, in the image. These contours are then quantified via metrics, such as CD. Thus, typically, the images of device structures are compared and quantified via simplistic metrics, such as an edge-to-edge distance (CD) or simple pixel differences between images. Typical contour models that detect the edges of the objects in an image in order to measure CD use image gradients. Indeed, those models rely on strong image gradients. But, in practice, the image typically is noisy and has discontinuous boundaries. Techniques, such as smoothing, adaptive thresholding, edge-detection, erosion, and dilation, may be used to process the results of the image gradient contour models to address noisy and discontinuous images, but will ultimately result in a low-resolution quantification of a high-resolution image. Thus, in most instances, mathematical manipulation of images of device structures to reduce noise and automate edge detection results in loss of resolution of the image, thereby resulting in loss of information. Consequently, the result is a low-resolution quantification that amounts to a simplistic representation of a complicated, high-resolution structure.

So, it is desirable to have a mathematical representation of the structures (e.g., circuit features, alignment mark or metrology target portions (e.g., grating features), etc.) produced or expected to be produced using a patterning process, whether, e.g., the structures are in a latent resist image, in a developed resist image or transferred to a layer on the substrate, e.g., by etching, that can preserve the resolution and yet describe the general shape of the structures. In the context of lithography or other pattering processes, the structure may be a device or a portion thereof that is being manufactured and the images may be SEM images of the structure. In some instances, the structure may be a feature of semiconductor device, e.g., integrated circuit. In this case, the structure may be referred as a pattern or a desired pattern that comprises a plurality of feature of the semiconductor device. In some instances, the structure may be an alignment mark, or a portion thereof (e.g., a grating of the alignment mark), that is used in an alignment measurement process to determine alignment of an object (e.g., a substrate) with another object (e.g., a patterning device) or a metrology target, or a portion thereof (e.g., a grating of the metrology target), that is used to measure a parameter (e.g., overlay, focus, dose, etc.) of the patterning process. In an embodiment, the metrology target is a diffractive grating used to measure, e.g., overlay.

FIG. 13 schematically illustrates a further embodiment of an inspection apparatus. The system is used to inspect a sample 90 (such as a substrate) on a sample stage 88 and comprises a charged particle beam generator 81, a condenser lens module 82, a probe forming objective lens module 83, a charged particle beam deflection module 84, a secondary charged particle detector module 85, and an image forming module 86.

The charged particle beam generator 81 generates a primary charged particle beam 91. The condenser lens module 82 condenses the generated primary charged particle beam 91. The probe forming objective lens module 83 focuses the condensed primary charged particle beam into a charged particle beam probe 92. The charged particle beam deflection module 84 scans the formed charged particle beam probe 92 across the surface of an area of interest on the sample 90 secured on the sample stage 88. In an embodiment, the charged particle beam generator 81, the condenser lens module 82 and the probe forming objective lens module 83, or their equivalent designs, alternatives or any combination thereof, together form a charged particle beam probe generator which generates the scanning charged particle beam probe 92.

The secondary charged particle detector module 85 detects secondary charged particles 93 emitted from the sample surface (maybe also along with other reflected or scattered charged particles from the sample surface) upon being bombarded by the charged particle beam probe 92 to generate a secondary charged particle detection signal 94. The image forming module 86 (e.g., a computing device) is coupled with the secondary charged particle detector module 85 to receive the secondary charged particle detection signal 94 from the secondary charged particle detector module 85 and accordingly forming at least one scanned image. In an embodiment, the secondary charged particle detector module 85 and image forming module 86, or their equivalent designs, alternatives or any combination thereof, together form an image forming apparatus which forms a scanned image from detected secondary charged particles emitted from sample 90 being bombarded by the charged particle beam probe 92.

In an embodiment, a monitoring module 87 is coupled to the image forming module 86 of the image forming apparatus to monitor, control, etc. the patterning process and/or derive a parameter for patterning process design, control, monitoring, etc. using the scanned image of the sample 90 received from image forming module 86. So, in an embodiment, the monitoring module 87 is configured or programmed to cause execution of a method described herein. In an embodiment, the monitoring module 87 comprises a computing device. In an embodiment, the monitoring module 87 comprises a computer program to provide functionality herein and encoded on a computer readable medium forming, or disposed within, the monitoring module 87.

In an embodiment, like the electron beam inspection tool of FIG. 12 that uses a probe to inspect a substrate, the electron current in the system of FIG. 13 is significantly larger compared to, e.g., a CD SEM such as depicted in FIG. 12, such that the probe spot is large enough so that the inspection speed can be fast. However, the resolution may not be as high as compared to a CD SEM because of the large probe spot. In an embodiment, the above discussed inspection apparatus may be single beam or a multi-beam apparatus without limiting the scope of the present disclosure.

The embodiments may further be described using the following clauses:

1. A vacuum system comprising:
a vacuum pump including a housing;
a vibration isolator coupled to the vacuum pump housing and configured to isolate vibrations generated by the vacuum pump during operation; and
a stop structure disposed between the vacuum pump housing and an adjacent fixture, the stop structure configured to prevent displacement of the vacuum pump housing relative to the fixture above a threshold amount, wherein the displacement of the vacuum pump housing is configured to be within the threshold amount during normal operation.
   2. The vacuum system of clause 1, wherein the vibration isolator inhibits transmission of the vibrations from the vacuum pump housing to a chamber within which vacuum is created by the vacuum pump.
   3. The vacuum system of clause 2, wherein the fixture forms part of the chamber.
   4. The vacuum system of any preceding clause, wherein during normal operation of the pump, the stop structure is spaced from the fixture.
   5. The vacuum system of clause 4, wherein the spacing is maintained between surfaces of the stop structure and the fixture in a radial direction.
   6. The vacuum system of clause 4, wherein the spacing is maintained between surfaces of the stop structure and the fixture in an axial direction.
   7. The vacuum system of any preceding clause, wherein the stop structure is configured to contact the fixture and prevent displacement of the vacuum pump housing above the threshold amount in an event of a malfunction of the vacuum pump.
   8. The vacuum system of clause 4, wherein the stop structure is fixed relative to the vacuum pump housing, and wherein the spacing between the vacuum pump housing and the fixture prevents vibration from being transmitted from the vacuum pump housing via the stop structure, to the fixture.
   9. The vacuum system of clause 8, wherein the stop structure is a separately formed structure that is fixedly connected to the vacuum pump housing.
   10. The vacuum system of clause 8, wherein the stop structure is integrally formed as part of the vacuum pump housing.
   11. The vacuum system of any of preceding clause, wherein the stop structure comprises one or more teeth.
   12. The vacuum system of clause 11, wherein the fixture comprises one or more slots to receive the one or more teeth of the stop structure.
   13. The vacuum system of clause 12, wherein the spacing is maintained between each of the one or more slots and the one or more teeth.
   14. The vacuum system of clause 13, wherein the one or more teeth of the stop structure contact slots of the fixture to prevent rotation of the vacuum pump upon malfunction.
   15. The vacuum system any of clauses 11-14, wherein the one or more teeth of the stop structure are made of a specified material that has a desired plastic deformation property to absorb kinetic energy of the vacuum pump upon failure.
   16. The vacuum system of any of preceding clause, wherein the stop structure is disposed between the vacuum pump and the vibration isolator and fixedly coupled to the vacuum pump and the vibration isolator.
   17. The vacuum system of any of clauses 2-16, wherein the chamber comprises a pocket to receive the vibration isolator and/or the stop structure.
   18. The vacuum system of any of clauses 1-17, further comprising:
a collar configured to prevent displacement of the vacuum pump housing along the axis of rotation of the vacuum pump above an axial threshold amount, wherein the displacement of the vacuum pump housing is configured to be within the axial threshold amount during normal operation.
   19. The vacuum system of clause 18, wherein the collar comprises one or more portions attached to a fixed structure, and shaped to conform with circumferential shape of the vacuum pump housing.
   20. The vacuum system of clause 19, wherein the collar has a ring like structure comprising:
a first portion; and
a second portion configured to couple with the first portion forming a ring, the first portion and the second portion configured to be attached around a circumference of the vacuum pump.
   21. The vacuum system of any of clauses 18-20, wherein the collar is normally spaced from the vacuum pump and the vibration isolator during operation of the vacuum pump.
   22. The vacuum system of any of clauses 18-21, wherein the collar is fixedly attached to a chamber.
   23. The vacuum system of any of clauses 18-22, wherein the collar is not directly coupled to the vacuum pump housing and maintains a spacing between the collar and the vacuum pump housing.
   24. The vacuum system of clause 23, wherein the spacing is maintained in a radial direction between the collar and a circumferential surface of the vacuum pump housing.
   25. The vacuum system of clause 24, wherein the spacing is maintained in an axial direction between the collar and the flange of the vacuum pump housing.
   26. A vacuum system comprising:
a vacuum pump including a housing;
a vibration isolator coupled to the vacuum pump housing and configured to isolate vibrations generated by the vacuum pump during operation; and
a collar axially coupled to the vacuum pump and configured to prevent displacement of the vacuum pump housing along the axis of rotation of the vacuum pump above an axial threshold amount, wherein the displacement of the vacuum pump housing is configured to be within the axial threshold amount during normal operation.
   27. The vacuum system of clause 25, wherein the collar comprises one or more portions attached to a fixed structure, and shaped to conform with circumferential shape of the vacuum pump housing.
   28. The vacuum system of clause 26, wherein the collar has a ring like structure comprising:
a first portion; and
a second portion configured to couple with the first portion forming a ring, the first portion and the second portion configured to be attached around a circumference of the vacuum pump.
   29. The vacuum system of any of clauses 26-28, wherein during normal operation the collar is spaced from the vacuum pump and the vibration isolator during operation of the vacuum pump in order to prevent vibration from being transmitted via the collar.
   30. The vacuum system of clause 29, wherein the collar being spaced from the vacuum pump and the vibration isolator reduces vibrations transmitted during operation of the vacuum pump from the vacuum pump to a chamber, within which vacuum is created by the vacuum pump, relative to when the collar is not spaced from the vacuum pump and the vibration isolator.
   31. The vacuum system of any of clauses 26-30, wherein the collar is fixedly attached to a chamber.
   32. The vacuum system of any of clauses 26-31, wherein the collar is not directly coupled to the vacuum pump housing and maintains a spacing between the collar and the vacuum pump housing.
   33. The vacuum system of clause 32, wherein the spacing is maintained in a radial direction between the collar and a circumferential surface of the vacuum pump housing.
   34. The vacuum system of clause 33, wherein the spacing is maintained in an axial direction between the collar and a flange of the vacuum pump housing.
   35. The vacuum system of any of clauses 26-34, further comprises: a stop structure disposed between the vacuum pump housing and an adjacent fixture, the stop structure configured to prevent displacement of the vacuum pump housing relative to the fixture above a threshold amount, wherein the displacement of the vacuum pump housing is configured to be within the threshold amount during normal operation.
   36. The vacuum system of clause 35, wherein the stop structure is normally spaced from the fixture during operation of the vacuum pump.
   37. The vacuum system of clause 36, wherein the spacing is maintained between surfaces of the stop structure and the vacuum pump housing in a radial direction.
   38. The vacuum system of clause 37, wherein the spacing is maintained between surfaces of the stop structure and the vacuum pump housing in an axial direction.
   39. The vacuum system of any of clauses 35-38, wherein the stop structure is configured to contact the fixture and prevent displacement of the vacuum pump housing above the threshold amount in an event of a malfunction of the vacuum pump.
   40. The vacuum system of clause 39, wherein the stop structure is fixed relative to the vacuum pump housing, and wherein the spacing between the vacuum pump housing and the fixture prevents vibration from being transmitted from the vacuum pump housing to the fixture.
   41. The vacuum system of clause 40, wherein the stop structure is a separately formed structure that is fixedly connected to the vacuum pump housing.
   42. The vacuum system of clause 41, wherein the stop structure is integrally formed as part of the vacuum pump housing.
   43. The vacuum system of any of clauses 35-42, wherein the stop structure comprises protruding structures.
   44. The vacuum system of clause 43, wherein the adjacent fixture comprises depressions corresponding to the protruding structures forming pairs of protruding structures and depressions.
   45. A system to mitigate damage and safety risk in an event of a pump failure, the system comprising:
a first component coupled to a pump and including protruding structures, the pump having a central axis; and
a second component coupled to a rigid structure and isolated from the pump by being separated from the pump, the isolation preventing vibration of the pump from being transmitted to the rigid structure via the second component, the second component including depressions that correspond to the protruding structures, wherein corresponding protrusion/depression pairs prevent the pump from rotating around the central axis beyond a threshold amount.
   46. The system of clause 45, further comprising: a third component coupled to the rigid structure that limits movement of the pump along the central axis direction beyond an axial threshold amount.
   47. The system of clause 45, wherein the vibration isolator inhibits transmission of the vibrations from a pump housing to a chamber within which vacuum is created by the pump.
   48. The system of clause 47, wherein the second component forms part of the chamber.
   49. The system of any of clauses 45-48, wherein during normal operation of the pump, the first component is spaced from the second component.
   50. The system of clause 49, wherein the spacing is maintained between surfaces of the first component and the second component in a radial direction.
   51. The system of clause 49, wherein the spacing is maintained between surfaces of the first component and the second component in an axial direction.
   52. The system of clause 51, wherein the first component is configured to contact the second component and prevent displacement of the pump housing above the threshold amount in an event of a malfunction of the pump.
   53. The system of any of clauses 45-52, wherein the first component is fixed relative to the pump housing, and wherein the spacing between the first component and the second component prevents vibration from being transmitted from the pump housing via the first component, to the second component.
   54. The system of clause 53, wherein the first component is a separately formed structure that is fixedly connected to the pump housing.
   55. The system of clause 53, wherein the first component is integrally formed as part of the pump housing.
   56. The system of any of clauses 45-55, wherein the protruding structures of the first component comprises one or more teeth.
   57. The system of clause 56, wherein the depressions of the second component comprises one or more slots to receive the one or more teeth of the first component.
   58. The system of clause 57, wherein the spacing is maintained between each of the one or more slots and the one or more teeth.
   59. The system of clause 58, wherein the one or more teeth of the first component contact slots of the second component to prevent rotation of the pump upon malfunction.
   60. The system any of clauses 56-59, wherein the one or more teeth of the first component are made of a specified material that has a desired plastic deformation property to absorb kinetic energy of the pump upon failure.
   61. The system of any of clauses 45-60, wherein the first component is disposed between the pump and the vibration isolator and fixedly coupled to the pump and the vibration isolator.
   62. The system of clause 46, wherein the third component comprises one or more portions attached to the rigid structure, and shaped to conform with circumferential shape of the pump housing.
   63. The system of clause 62, wherein the third component has a ring like structure comprising: a first portion; and a second portion configured to couple with the first portion forming a ring, the first portion and the second portion configured to be attached around a circumference of the pump.
   64. The system of any of clauses 62-63, wherein during normal operation, the third component is normally spaced from the pump and the vibration isolator to prevent vibration from the pump being transmitted via the third component.
   65. The system of any of clauses 62-64, wherein the third is fixedly attached to the rigid structure.
   66. The system of any of clauses 62-65, wherein the third component is not directly coupled to the pump housing and maintains a spacing between the third component and the pump housing.
   67. The system of clause 66, wherein the spacing is maintained in a radial direction between the third component and a circumferential surface of the pump housing.
   68. The system of clause 67, wherein the spacing is maintained in an axial direction between the third component and a flange of the pump housing.

Additional examples of metrology apparatus is disclosed in PCT application PCT/EP2016/080058 and U.S. Pat. No. 10,254,644, which are both incorporated herein by reference in its entirety.

Modifications and alternative embodiments of various aspects of the inventions will be apparent to those skilled in the art in view of this description. Accordingly, this description and the drawings are to be construed as illustrative only and are for the purpose of teaching those skilled in the art the general manner of carrying out the inventions. It is to be understood that the forms of the inventions shown and described herein are to be taken as examples of embodiments. Elements and materials may be substituted for those illustrated and described herein, parts and processes may be reversed or omitted, certain features may be utilized independently, and embodiments or features of embodiments may be combined, all as would be apparent to one skilled in the art after having the benefit of this description. Changes may be made in the elements described herein without departing from the spirit and scope of the invention as described in the following claims. Headings used herein are for organizational purposes only and are not meant to be used to limit the scope of the description.

While the concepts disclosed herein may be used for imaging on a substrate such as a silicon wafer, it shall be understood that the disclosed concepts may be used with any type of lithographic imaging systems, e.g., those used for imaging on substrates other than silicon wafers.

As used herein, unless specifically stated otherwise, the term “or” encompasses all possible combinations, except where infeasible. For example, if it is stated that a database can include A or B, then, unless specifically stated otherwise or infeasible, the database can include A, or B, or A and B. As a second example, if it is stated that a database can include A, B, or C, then, unless specifically stated otherwise or infeasible, the database can include A, or B, or C, or A and B, or A and C, or B and C, or A and B and C.

The descriptions above are intended to be illustrative, not limiting. Thus, it will be apparent to one skilled in the art that modifications may be made as described without departing from the scope of the claims set out below.

To the extent certain U.S. patents, U.S. patent applications, or other materials (e.g., articles) have been incorporated by reference, the text of such U.S. patents, U.S. patent applications, and other materials is only incorporated by reference to the extent that no conflict exists between such material and the statements and drawings set forth herein. In the event of such conflict, any such conflicting text in such incorporated by reference U.S. patents, U.S. patent applications, and other materials is specifically not incorporated by reference herein.

While certain embodiments have been described, these embodiments have been presented by way of example only, and are not intended to limit the scope of the present disclosures. Indeed, the novel methods, apparatuses and systems described herein can be embodied in a variety of other forms; furthermore, various omissions, substitutions and changes in the form of the methods, apparatuses and systems described herein can be made without departing from the spirit of the present disclosures. The accompanying claims and their equivalents are intended to cover such forms or modifications as would fall within the scope and spirit of the present disclosures.

1. A vacuum system comprising:
a vacuum pump including a housing;
a vibration isolator coupled to the vacuum pump housing and configured to isolate vibrations generated by the vacuum pump during operation; and
a stop structure disposed between the vacuum pump housing and an adjacent fixture, the stop structure configured to prevent displacement of the vacuum pump housing relative to the fixture above a threshold amount, wherein the displacement of the vacuum pump housing is configured to be within the threshold amount during normal operation.

2. The vacuum system of claim 1, wherein the vibration isolator is configured to inhibit transmission of the vibrations from the vacuum pump housing to a chamber within which vacuum is created by the vacuum pump.

3. The vacuum system of claim 2, wherein the fixture forms part of the chamber.

4. The vacuum system of claim 1, wherein during normal operation of the pump, the stop structure is spaced from the fixture.

5. The vacuum system of claim 4, wherein the spacing is maintained between surfaces of the stop structure and the fixture in a radial direction.

6. The vacuum system of claim 4, wherein the spacing is maintained between surfaces of the stop structure and the fixture in an axial direction.

7. The vacuum system of claim 1, wherein the stop structure is configured to contact the fixture and prevent displacement of the vacuum pump housing above the threshold amount in an event of a malfunction of the vacuum pump.

8. The vacuum system of claim 4, wherein the stop structure is fixed relative to the vacuum pump housing, and wherein the spacing between the vacuum pump housing and the fixture prevents vibration from being transmitted from the vacuum pump housing via the stop structure, to the fixture.

9. The vacuum system of claim 1, wherein the stop structure is a separately formed structure that is fixedly connected to the vacuum pump housing.

10. The vacuum system of claim 1, wherein the stop structure is integrally formed as part of the vacuum pump housing.

11. The vacuum system of claim 1, wherein the stop structure comprises one or more teeth.

12. The vacuum system of claim 11, wherein the fixture comprises one or more slots to receive the one or more teeth of the stop structure.

13. The vacuum system of claim 12, wherein a spacing is maintained between each of the one or more slots and the one or more teeth.

14. The vacuum system of claim 13, wherein the one or more teeth of the stop structure contact the one more slots of the fixture to prevent rotation of the vacuum pump upon malfunction.

15. The vacuum system of claim 11, wherein the one or more teeth of the stop structure are made of a specified material that has a desired plastic deformation property to absorb kinetic energy of the vacuum pump upon failure.

16. The vacuum system of claim 1, wherein the stop structure is disposed between the vacuum pump and the vibration isolator and fixedly coupled to the vacuum pump and the vibration isolator.

17. The vacuum system of claim 2, wherein the chamber comprises a pocket to receive the vibration isolator and/or the stop structure.

18. The vacuum system of claim 1, further comprising a collar configured to prevent displacement of the vacuum pump housing along an axis of rotation of the vacuum pump above an axial threshold amount, wherein the displacement of the vacuum pump housing is configured to be within the axial threshold amount during normal operation.

19. The vacuum system of claim 18, wherein the collar comprises one or more portions attached to a fixed structure, and shaped to conform with a peripheral shape of the vacuum pump housing.

20. The vacuum system of claim 19, wherein the collar has a ring like structure comprising:
a first portion; and
a second portion configured to couple with the first portion forming a ring, the first portion and the second portion configured to be attached around a periphery of the vacuum pump.
